(19) United States
(12) Patent Application Publication
(10) Pub. No.: US 2002/0160200 A1
(43) Pub. Date: Oct. 31, 2002

(54) Electroconductive endless-belt and image formation apparatus

(75) Inventor: Norihiko Kaga, Kodaira-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Bridgestone Corporation, Tokyo (JP)

(21) Appl. No.: 10/080,669

(22) Filed: Feb. 25, 2002

(30) Foreign Application Priority Data
Feb. 27, 2001 (JP) 2001-52727
Oct. 5, 2001 (JP) 2001-309425

(51) Int. Cl. B32B 27/36

(52) U.S. Cl. 428/412; 428/474.4; 428/480

(57) ABSTRACT

An electroconductive endless-belt of tandem system circulatorily for transfer and/or conveyance which is circulatorily driven by a drive unit, and which conveys a recording medium retained on the belt by electrostatic attraction to four kinds of image formation members, and sequentially transfers each toner image onto the recording medium, characterized in that the endless belt comprises as a base material, at lease one member selected from the group consisting of acrylonitrile-styrene resin containing 3 to 50 mass % of a flexible component having glass transition temperature lower than 25° C., a polymer alloy of thermo plastic resin with acrylonitrile-styrene resin containing 3 to 50 mass % of a flexible component having glass transition temperature lower than 25° C., and a polymer blend of thermo plastic resin with acrylonitrile-styrene resin containing 3 to 50 mass % of a flexible component having glass transition temperature lower than 25° C., and an image formation apparatus equipped with the endless-belt. The belt is excellent in strength, folding endurance, creep durability and dimensional stability.

### BACKGROUND OF THE INVENTION

1. Field of the Invention

The present invention relates to an electroconductive endless-belt (hereinafter, sometimes referred to as “the belt”) to be used for transfer of a toner image, which is obtained by supplying a toner onto the surface of an image formation body such as a latent image retainer and the like, onto a recording medium such as paper in electrostatic recording processes for an electrophotographic apparatus such as copying machinery, printer and so on, an electrostatic recording apparatus and the like. Further the present invention relates to an image formation apparatus equipped with the belt.

2. Description of the Related Art

In the conventional electrostatic recording processes such as copying machinery, printer and the like, the following processes have been applied; that is, the surface of a photosensitive body (ex. a latent image retainer) is charged uniformly as the first step, then exposing an image from an optical system on a photosensitive body to remove the charge of the exposed area so as to thereby form an electrostatic latent image, subsequently supplying the electrostatic latent image with a toner to form a toner image caused by electrostatic attraction, and finally the resultant toner image is transferred onto a recording medium such as paper, OHP, photographic paper, and the like.

Likewise in color printers and color copying machinery, printing is carried out fundamentally based on the aforementioned processes. In the case of color printing, because the color tone is reproduced by the use of four toners of magenta, yellow, cyan and black, there is a necessary step to obtain the desired color tone by superimposing the aforementioned toners at a prescribed ratio. There have been proposed several systems so as to carry out the above step.

As a first system, there is a multiple development system, in which a colored toner image is primarily formed on a photosensitive body by superimposing the aforementioned four toners of magenta, yellow, cyan and black sequentially. Thereby an electrostatic latent image is visualized on the photosensitive body similar to the black-and-white printing by supplying a toner. The system, although being capable of providing a comparatively compact type with a development unit, involves an extreme difficulty of the gradation control, therefore makes it impossible to obtain a high quality image.

As a second system, there is a tandem system in which four photosensitive drums are installed. A latent image of each drum is developed with one of the toners, magenta, yellow, cyan and black, thereby forming color toner images of the magenta toner image, the yellow toner image, the cyan toner image and the black toner image respectively. The photosensitive bodies on which these toner images are formed are arranged in a row and each of images is sequentially transferred to a recording medium such as paper and the like, and the images thus transferred are superimposed on the recording medium so as to reproduce the color images. The system produces favorable images, however, an apparatus is a large-sized as well as very expensive due to use of the four drums, arranging the four drums in a row and each of them being provided with electrically charging mechanism and development mechanism.

FIG. 2 is a structural illustration of a printing member for an image formation apparatus of the tandem system. A development unit comprises a photosensitive drum 1, a charger roll 2, a development roll 3, a development blade 4, a toner supplying roll 5 and a cleaning blade 6. The four development units are arranged corresponding to each toner of yellow Y, magenta M, cyan C and black B, and the toners are sequentially transferred onto the paper supplied by a transfer-conveyance belt 10 which is driven circulatory by a drive roller (a drive unit) 9. The charger roll or a charge-elimination roll does charge-injection or charge-elimination of the transfer-conveyance belt respectively. Further, the paper is charged by an attraction roller (not illustrated) so as to be attracted onto the belt. These procedures reduce generation of ozone. At the attraction roller, the paper is put on the transfer-conveyance belt from a supply route and also an electrostatic attraction to the transfer-conveyance belt occurs. The separation of the paper after the transfer is simply done through curvature separation based on a weakened attraction power between paper and the transfer-conveyance belt by a lowered transfer voltage.

There are a resistive material and a dielectric material as material for the transfer-conveyance belt, and each has merits and demerits respectively. Since the resistive material belt retains the charge in a short period of time if it is applied to the tandem system, the charge-injection in case of the transfer and the voltage rising are low, even though in case of consecutive transfer of the four colors. Further the charge is eliminated when it is repeatedly used for transferring onto another paper, therefore electrical resetting is not required. However there are demerits such as adverse affect on transfer efficiency due to varying the resistance value by environmental change and also probable adverse affect caused by thickness or width of the paper.

On the other hand, in the case of the dielectric material belt, there is no spontaneous elimination of the injected charge, therefore the charge-injection as well as the charge-elimination should be controlled electrically. However, the attraction of the paper is reliable and the paper supply with high precision is possible since the charge is retained stable. The demerit is a higher transfer voltage required since the charge is accumulated on the belt on each transfer.

As a third system, there is a transfer drum system in which a recording medium such as paper and the like is wound around a transfer drum. Subsequently the drum is rotated four times, while toners of magenta, yellow, cyan and black on the photosensitive body are sequentially transferred onto a recording medium per each one rotation so as to reproduce color images. Although the system produces relatively high quality images, there is a demerit of restricting the kind of the recording medium to be used since a thick sheet of paper such as a postcard is difficult to wind around the transfer drum.

As a countermeasure against the aforementioned multiple development system, tandem system and transfer system, there has been proposed an intermediate transfer system as a system capable of producing an excellent quality of image without making a large-sized apparatus in particular or restricting, especially, the kind of a recording medium.

The intermediate transfer system is a system comprising the following: installing, in the system, an intermediate transfer member made up of a drum or a belt which once transfers and retains the toner images on a photosensitive body to and on itself. The images are sequentially transferred onto the intermediate transfer member, the four toner images with magenta, yellow, cyan and black respectively so as to form color toner images on the intermediate transfer member; further transferring the resultant color images onto a recording medium such as paper and the like. Therefore, the intermediate transfer system is capable of producing high quality images since the system controls the gradation by superimposing the four color toner images, and also does not require a large-sized apparatus, differing from the tandem system, since it is not necessary to arrange the drums in a row. Further it does not restrict the kind of a recording medium since there is no need to wind a recording medium around the drum. Furthermore, there is a tandem-intermediate transfer system by combining the tandem system with the intermediate transfer system.

FIG. 3 illustrates, as a color image forming apparatus of the intermediate transfer system, an image formation apparatus in which an intermediate transfer member of an endless belt type is used as the intermediate transfer member.

In FIG. 3, numerical symbol 11 means a drum type photosensitive body and it rotates in the direction indicated by the arrow. The photosensitive body 11 is charged by a primary charger unit and then the charge of the exposed area is eliminated by an image exposure 13 so as to form an electrostatic latent image corresponding to a primary color component on the photosensitive body 11. Further, the electrostatic latent image of the magenta toner M as the primary color is developed by a development unit 41 and the magenta toner image is formed on the photosensitive body 11. Thereafter the toner image is transferred onto the intermediate transfer member 20, which is driven circulatory by a drive roller (a drive unit) 30, rotating circulatory while contacting with the photosensitive body 11. Thus, the transfer from the photosensitive body 11 onto the intermediate transfer member 20 is carried out at the nip part between the photosensitive body 11 and the intermediate transfer member 20 by a primary transfer bias impressed from a electric power source 61 to the intermediate transfer member. The development transfer operation for the first rotation of the photosensitive body 11 is completed when its surface is cleaned with a cleaning unit 14. Further the photosensitive body rotates three times and the second-cyan toner image, the third-yellow toner image and the forth-black toner image are sequentially formed on the photosensitive body 11 at each one rotation. These images are sequentially superimposed on the intermediate member 20 at each one rotation by utilizing development units 42 to 44 in turn, thereby color toner images corresponding to the objective color image are formed on the intermediate member 20. In FIG. 3, the developments by the magenta toner M, cyan toner C, yellow toner Y and black toner B are carried out sequentially by counterchanging the development units 42 to 44 in turn at each one rotation of the photosensitive body 11.

Subsequently, the intermediate transfer member 20, on which the aforementioned superimposed color toner images are formed, is contacted by a transfer roller 25, to the nip part thereof, a recording medium 26 such as paper and the like is supplied from its supply cassette 19. Simultaneously a secondly transfer bias is impressed from an electric power source 29 to the transfer roller, thereby the superimposed color toner images is transferred from the intermediate transfer member 20 onto the recording medium 26 and heat-fixed on it as an objective image. The intermediate transfer member 20 after having transferred the superimposed color toner images onto the recording medium 26 is returned to the initial state so as to be ready for next image formation since the remaining toner on the surface is removed by a cleaning unit 35.

Semi-conductive resin film belts and fiber-reinforced rubber belts have been utilized as an intermediate member of an endless belt type 20. Among them, polycarbonate blended with carbon black has been well known as a semi-conductive resin film belt, however, there have recently been proposed a resin film belt based on polyalkylene terephthalate improved with folding endurance (Japanese Patent Application No. H8-99375/1996), a resin film belt based on thermoplastic polyimide having improved elasticity (Japanese Patent Application No. H11-17038/1999) and the like.

In an image formation apparatus of the tandem system, the intermediate transfer system and the tandem intermediate transfer system using an electroconductive endless belt, any electroconductive endless belt is required to be provided with durable strength, particularly folding endurance and creep durability, for repeated consecutive use.

Some of semi-conductive resin film belts have been put to practical use, however, the belt having more improved than the aforementioned qualities is nowadays demanded.

### SUMMARY OF THE INVENTION

The objective of the present invention is to provide an electroconductive endless-belt having good strength, particularly excellent folding endurance and creep durability, furthermore dimensional stability, and also to provide an image formation apparatus equipped with the belt.

In such circumstances, as a result of intensive research and development done diligently by the present inventors, it is found that the aforementioned objective has been achieved by using an acrylonitrile-styrene resin(AS resin) containing 3 to 50 mass % of an elastic component having the glass transition temperature Tg lower than 25° C., or a polymer alloy or a polymer blend of the AS resin with a thermoplastic resin, whereby the present invention has been accomplished. That is to say, the present invention is explained as follows;

(1) An electroconductive endless-belt of tandem system for transfer and/or conveyance which is circulatory driven by a drive unit, and which conveys a recording medium retained on the belt by electrostatic attraction to four kinds of image formation members and each toner image sequentially transfers belt comprises as a base material onto the recording medium, characterized in that acrylonitrile-styrene resin containing 3 to 50 mass % of a flexible component having glass transition temperature lower than 25° C., a polymer alloy of a thermo-plastic resin with acrylonitrile-styrene resin containing 3 to 50 mass % of a flexible component having glass transition temperature lower than and a polymer blend of a thermoplastic resin with acrylonitrile-styrene resin containing 3 to 50 mass % of a flexible component having glass transition temperature lower than 25° C.

(2) An electroconductive endless-belt which is used for an intermediate transfer member, is located between an image formation body and a recording medium, and is circulatorily driven with a drive unit, thereby once transferring and retaining on the surface of itself, a toner image formed on the surface of the image formation body, and then transferring the image thereon onto the recording medium, characterized in that the endless-belt comprises as a base material, at lease one member selected from the group consisting of as a base, acrylonitrile-styrene resin containing 3 to 50 mass % of a flexible component having glass transition temperature lower than 25° C., a polymer alloy of a thermoplastic resin with acrylonitrile-styrene resin containing 3 to 50 mass % of a flexible component having glass transition temperature lower than 25° C., and a polymer blend of a thermo-plastic resin with acrylonitrile-styrene resin containing 3 to 50 mass % of a flexible component having glass transition temperature lower than 25° C.

(3) The electroconductive endless-belt of aforementioned (1) or (2), characterized in that said elastic component is acrylic rubber, chlorinated polyethylene, polybutadiene rubber, ethylene-propylene rubber or silicone rubber.

(4) The electroconductive endless-belt of above (3), characterized in that said elastic component is polybutadiene rubber.

(5) The electroconductive endless-belt of aforementioned (1) to (4), characterized in that said thermoplastic resin is a thermoplastic elastmer.

(6) The electroconductive endless-belt of aforementioned (1) to (4), characterized in that said thermoplastic resin is polybutylene terephthalate.

(7) The electroconductive endless-belt of aforementioned (1) to (4), characterized in that said thermoplastic resin is polycarbonate.

(8) The electroconductive endless-belt of aforementioned (1) to (4), characterized in that said thermoplastic resin is polyamide.

(9) The electroconductive endless-belt of aforementioned (5), characterized in that said thermoplastic resin is a thermoplastic elastmer containing a polyether component.

(10) The electroconductive endless-belt of aforementioned (1) to (9), comprising a thermoplastic resin in corporates with an electroconductive material as a functional component.

(11) The electroconductive endless-belt of aforementioned (10), comprising a thermoplastic resin incorporated with 0.1 to 100 parts by mass of carbon black as an electroconductive material of a functional component based on 100 parts by mass of the resin.

(12) The electroconductive endless-belt of aforementioned (1) to (11), wherein its volume resistance is 10⁶ to 10¹³ Ω·cm.

(13) The electroconductive endless-belt of aforementioned (1) to (12), wherein an engaging member, with which the drive unit engages, is provided on the contacting side of the belt with the drive unit.

(14) The electroconductive endless-belt of above (13), wherein the engaging member is a continuous protruded convexity along the rotating direction.

(15) An image formation apparatus equipped with an electroconductive endless-belt of aforementioned (1) to (14).

### BRIEF DESCRIPTION OF THE DRAWINGS

FIG. 1 is a cross sectional view in the width-direction of an electroconductive endless-belt in an example of the present invention.

FIG. 2 is a schematic illustration of an example of an image formation apparatus of the tandem system employing a transfer-conveyance belt as an example of an image formation apparatus according to the present invention.

FIG. 3 is a schematic illustration of an example of an image formation apparatus of the intermediate transfer system employing an intermediate transfer member as another example of an image formation apparatus according to the present invention.

The aforementioned electroconductive endless-belt of the present invention is provided with excellent strength, in particular excellent folding endurance and creep resistance, and also excellent dimensional precision. Further, in case that the engaging member is provided so as to engage the drive unit with the electroconductive endless-belt each other, it is possible to avoid the belt, which is built over two or more axles with reasonable tension, from misalignment in the cross-belt direction. Furthermore, by using the image formation apparatus of the present invention, it is possible to produce excellent objective images without generating an inferior product during long term operation.

### DETAILED DESCRIPTION OF THE INVENTION

The following is the description of embodiments for the present invention. Although there are generally two types of the electroconductive endless-belt having a joint and also having no joint (namely seamless type), both types are usable for the present invention. The electroconductive endless-belt of the present invention is, as aforementioned, to be used as a transfer member and the like for the tandem system, the intermediate transfer system and the tandem intermediate transfer system.

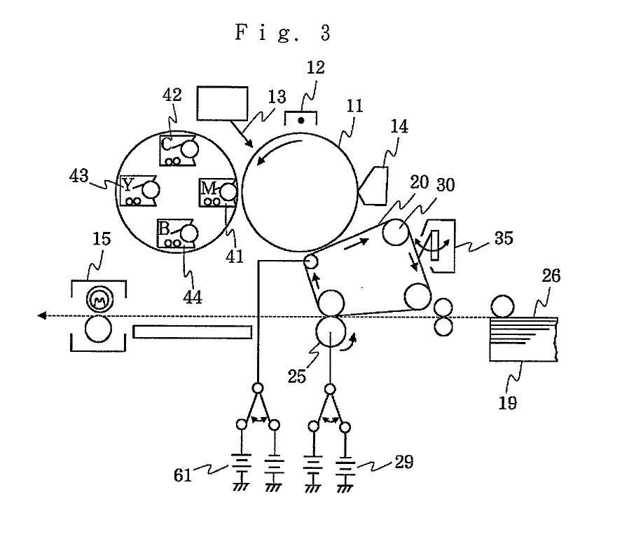

An electroconductive endless-belt of the present invention is, for example, to be used as a transfer-conveyance belt shown by the numerical symbol 10 in FIG. 2. A drive unit such as a drive roller 9 and the like drives the belt, thereby the toners are transferred sequentially onto a recording medium, which is conveyed with the belt, so as to form an objective color image.

Further, an electroconductive endless-belt of the present invention being used as an intermediate transfer member shown by the numerical symbol 20 in FIG. 3 is located between a photosensitive drum (a latent image retainer) 11 and driven circulatory by a drive roller 30 and the like. Therefore, the toner images formed on the surface of the photosensitive drum 11 is transferred and retained once on the belt; followed by transferring the toner images onto a recording medium 26 and the like. The apparatus shown in FIG. 3 is to produce an objective color image by the intermediate transfer system as aforementioned.

Acrylonitrile-styrene resin containing 3 to 50 mass % of an elastic component having glass transition temperature lower than 25° C., preferably 3 to 33 mass %, and more preferably 5 to 25 mass % is usable for an electroconductive endless-belt of the present invention and is thermoplastic resin with excellent impact resistance property and dimensional stability. As an elastic component, there are many kinds of resins and rubber such as acrylic rubber, chlorinated polyethylene, polybutadiene rubber, ethylene propylene rubber and silicone rubber. In case of that acrylic rubber is used as an elastic component, it is acrylonitrile-acrylic rubber-styrene resin [ASA (AAS) resin]. In case of using chlorinated polyethylene, acrylonitrile-chlorinated polyethylene-styrene resin (ACS resin), in case of polybutadiene rubber, acrylonitrile-butadiene-styrene resin (ABS resin), in case of ethylene propylene rubber, acrylonitrile-ethylene propylene-styrene resin (AES resin) and in case of silicone rubber, acrylonitrile-silicone-styrene resin (ASS resin).

In the present invention, acrylonitrile-butadiene-styrene resin is preferable due to its excellent impact resistance and dimensional stability thereof, and also easy availability at the market. For example, acrylonitrile-butadiene-styrene resin; the trade name: Cevian V320 produced by Daicel Polymer Ltd. and the like is to be usable as typical resins. If such acrylonitrile-butadiene-styrene resin is used for the base material of the electroconductive endless-belt, the electroconductive endless-belt thereof having stable resistance, good strength, in particular excellent folding endurance, and high dimensional stability, is obtained.

Further, in the present invention, a polymer alloy or a polymer blend comprising acrylonitrile-styrene resin, which contains 3 to 50 mass % of an elastic component having glass transition temperature lower than 25° C., with thermoplastic resin, particularly thermoplastic elastmer is usable, preferably a polymer alloy comprising acrylonitrile-butadiene-styrene resin and thermoplastic polypropylene terephthalate. It is possible to obtain, at the market, a polymer alloy and a polymer blend comprising such acrylonitrile-butadiene-styrene resin and thermoplastic polybutylene terephthalate. For example, Novalloy B1500 produced by Daicel Polymer Ltd. and the like is a typical product.

Furthermore, it is possible to incorporate an electroconductive imparting material as a functional component into acrylonitrile-butadiene-styrene resin polymer as the base material for the electroconductive endless-belt, or a polymer alloy or a polymer blend of thermoplastic resin with it. In this case, since there is no specific limitation for such an electroconductive imparting material, the following are illustrative;

1) Cationic surfactant of quaternary ammonium and the like of perchlorate, chlorate, hydroborofluorid, hydrosulfate, ethosulfate or benzyl halogenide (benzyl bromide salt, benzyl chloride salt, etc.) of lauryl trimethyl ammonium, stearyl trimethyl ammonium, octadecyl trimethyl ammonium, dodecyl trimethyl ammonium, hexadecyl trimethyl ammonium or modified fatty acid.dimethyl ethyl ammonium;

2) Anionic surfactant such as aliphatic sulfonate, higher alcohol sulfate ester, ethylene oxide higher alcohol adduct sulfate, higher alcohol phosphate and the like;

3) Amphoteric surfactant such as various betaine and the like,

4) Nonionic antistatic agent such as higher alcohol ethylene oxide, polyethylene glycol fatty acid ester and polyhydric alcohol fatty acid ester and the like;

5) Metal salt of number 1 group of the periodic table such as LiCF₂SO_{2,} NaClO_{4,} LiBF_{4,} NaCl and the like;

6) Metal salt of number 2 group of the periodic table such as Ca(ClO₄)₂ and the like; and

7) These antistatic agents having one or more group containing one and more active hydrogen (hydrogen group, carboxyl group, primary or secondary amine group) reacting with isocyanate group, and the like.

Furthermore, the following is illustrative of electroconductive materials; 1) namely ionic antistatic agents such as complex compounds and the like of the aforementioned compounds with polyhydric alcohol such as 1, 4-butandiol, ethylene glycol, polyethylene glycol, propylene glycol and the like or derivatives thereof; and complex compounds and the like of the aforementioned compounds with ethylene glycol monomethyl ether, ethylene glycol monoethyl ether and the like; 2) electroconductive carbon such as Ketzen-black, acetylene black and the like; 3) carbon for rubber such as SAF,I SAF, HAF, FEF, GPF, SRF, FT, MT and the like; 4) oxidized carbon for color ink, pyrolysis carbon, natural graphite, artificial graphite and the like; 5) metal and metal oxide such as tin oxide, titanium oxide, zinc oxide, nickel, copper and the like; 6) electroconductive polymer such as polyaniline, polypyrrol, polyacetylene and the like.

Incorporating amount of these electroconductive imparting material to the base resin is, in case of carbon black as an electroconductive material, 0.1 to 100 parts by mass, preferably 0.5 to 50 parts by mass based on 100 parts by mass of the resin so as to control the volume resistance of the elastic material layer to 10⁶ to 10¹³ Ω·cm, preferably 10⁷ to 10¹² Ω·cm.

Further, it is possible, if desired, to add other functional components unless adversely affecting the present invention; for examples, a reasonable amount of various fillers, coupling agent, antioxidant, lubricant, surface treatment agent, pigment, ultraviolet absorber, antistatic agent, dispersing agent, neutralization agent, cross-linking agent, compatibility agent and the like.

Although the thickness of an electroconductive endless belt is reasonably selected based on a type of a transfer belt or an intermediate transfer belt, the preferable range is 50 to 200 μm.

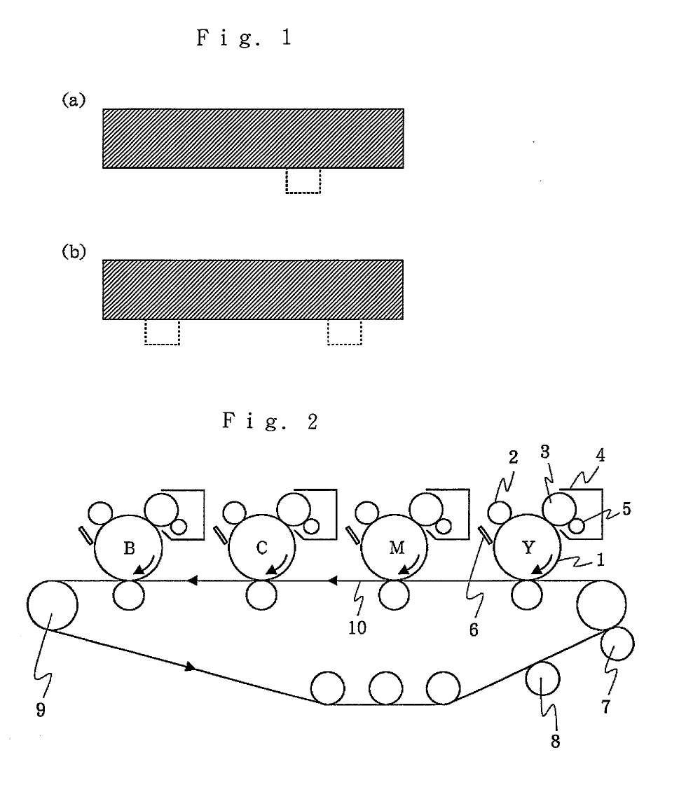

Further, it is possible to equip a surface of an electroconductive endless-belt of the present invention with a engaging member as indicated by a dashed line in FIG. 1. The engaging member contacts with a drive unit such as a drive roller 9 of an image formation apparatus in FIG. 2 or drive rollers 30 in FIG. 3 so as to engage with a engaging member (not illustrated) of the drive units. By providing the electroconductive endless-belt of the present invention with such a engaging member, the belt is conveyed while engaging with the engaging member of a drive unit (not illustrated) so as to prevent the belt from misalignment in the cross-belt direction.

In this case, although it is not restricted, it is preferable that the engaging member is a continuous protruded convexity along its ambi-direction (the rotating direction) so as to mate with a groove providing on ambi-face (in the ambi-direction) of a drive member of a drive unit and the like as shown in FIG. 1.

Although a continuous protruded convexity as a engaging member is illustrated in FIG. 1(a), it is also possible to provide with many types of convexities such as a engaging member in the ambi-direction (the rotating direction) of the belt, two or more of engaging members as shown in FIG. 1(b), or it in the center part of the belt-cross direction. Furthermore, in place of a engaging member of the convex shape as shown in FIG. 1, it is possible to provide with a groove in the ambi-direction (in the rotating direction) of the belt so as to engage with a convex engaging member in the ambi-direction on ambi-face of a drive unit of said drive roller and the like.

In an electroconductive endless-belt of the present invention, although not being restricted particularly, it is preferable to control its surface roughness to 10 μm or less, particularly 6 μm or less, furthermore 3 μm or less at ten-point average roughness Rz in accordance with JIS test method.

Further, as an image formation apparatus equipped with the electroconductive endless belt of the present invention, it is possible to exemplify the tandem system shown in FIG. 2, the intermediate system shown in FIG. 3 or the tandem intermediate system, but it is not restricted. Further, in case of the apparatus of FIG. 3, it is possible to charge a voltage from a electric power source 61 to a drive roller or a driving gear which rotates the intermediate transfer member of the present invention. Such a charge condition is optionally selected from the conditions of charge by a direct current only, charge by a direct current superposed by an alternating current and the like.

Although a manufacturing process of an electroconductive endless-belt is not particularly restricted, for example, it is possible to manufacture as follows; a resin component (acrylonitrile-styrene resin containing 3 to 50 mass % of a flexible component having glass transition temperature lower than 25° C., or a polymer alloy or a polymer blend comprising a thermoplastic resin therewith) and a functional component such as electroconductive material and the like are blended by using a biaxial kneading machine followed by extrusion molding of the mixture through a ring shaped die. In addition to the above, powder coating such as electrostatic coating, solution dip method or centrifugal casting method is to be suitably employed.

As explained above, the present invention is possible to produce an electroconductive endless-belt having good strength, in particular excellent folding endurance and creep resistance, and also excellent dimensional precision. Further, an image formation apparatus equipped with the electroconductive endless-belt is possible to produce excellent objective images without producing any inferior image after a long term operation.

The present invention is explained with reference to the following examples.

### EXAMPLE 1

A hundred parts by mass of an acrylonitrile-butadiene-styrene resin (Cevian V510 containing 10 weight % of butadiene manufactured by Daicel Polymer Ltd.) and 30 parts by mass of DENKA BLACK (manufactured by DENKI KAGAKU KOGYO CO., LTD.) were melted and kneaded by using a twin-screw kneading machine, then the mixture therefrom was extruded so that the electroconductive endless-belt having inner-diameter of 245 mm, thickness of 100 μm and width of 250 mm was produced. The repeated count of the folding endurance test of the belt was measured by using MIT type folding endurance tester manufactured by Toyo Seiki Ltd. The tension creep test was carried out under the condition of the temperature of 25° C. for 1200 hours in accordance with the JIS K7115 test method. Further, the measurement of the specific volume resistance was carried out under the condition of the temperature of 20° C., the relative humidity of 50% and the voltage of 100V by using the ohm meter R8340A(manufactured by ADVANTEST CORP.) connected with the sample-chamber R12704A.

### EXAMPLE 2

In place of the acrylonitrile-butadiene-styrene resin, by using the polymer alloy of an acrylonitrile-butadiene-styrene resin with a polybuthylene terephthalate (Novalloy B1700 containing butadiene of 15 mass % manufactured by Daicel Polymer Ltd.) and applying the same method as Example 1, an electroconductive endless-belt was manufactured and measured.

### EXAMPLE 3

In place of the acrylonitrile-butadiene-styrene resin, by using the polymer blend as the base resin obtained by blending an acrylonitrile-butadiene-styrene resin (Cevian V510 containing 10 mass % of butadiene manufactured by Daicel Polymer Ltd.) of 80 parts by weight with a thermoplastic polyether elastmer (PELPRENE E-450B manufactured by Toyobo. Co. Ltd.) of 20 parts by mass, into which DENKA BLACK (manufactured by DENKI KAGAKU KOGYO K.K.) of 30 parts by mass based on the base resin was incorporated, and applying the same method as Example 1, an electroconductive endless-belt was manufactured and measured.

### EXAMPLE 4

By using an acrylonitrile-butadiene-styrene resin (Cevian V510 manufactured by Daicel Polymer Ltd.) of 100 parts by mass and an antistatic agent (IRGASTAT P-18 manufactured by Ciba-Geigy Corporation) of 30 parts by mass, the same method shown in Example 1 was applied to manufacture and measure an electroconductive endless-belt thereof.

### EXAMPLE 5

In place of an acrylonitrile-butadiene-styrene resin, by using an acrylonitrile-acrylic rubber-styrene resin (Luran S-757RE containing acrylic rubber of 15 mass % therein manufactured by BASF), the same method as Example 1 was applied to manufacture an electroconductive endless-belt, and also the same method was applied to make the measurement.

### Comparative EXAMPLE 1

In place of an acrylonitrile-butadiene-styrene resin, thermoplastic polycarbonate resin (Panlite 1300Y manufactured by Teijin Chemical Ltd.) and FEF carbon (manufactured by Asahi Carbon Ltd.) of 30 weight % were used, and the same methods as Example 1 were applied to manufacture and measure an electroconductive endless-belt therefrom.

Further, the electroconductive endless-belts of the above Examples and Comparative Example were respectively installed to a tandem system image formation apparatus used a transfer-conveyance belt shown in FIG. 2, and then a transfer operation was repeated to carry out the durability test of A4 size printing papers of 100,000 sheets. During the transfer operation, it is investigated, as needed, as to whether or not there is flex-cracking by observing the surface of the belt. By using the results therefrom, quality of the objective image and the surface of the belt were evaluated.

The results of aforementioned volume resistance value, the repeated count of folding endurance test and creep durability test were shown in the Table 1. By the way, the repeated count of folding endurance test of each Example was 100 and more, therefore it was shown by index in the Table 1.

TABLE 1

| | Example | Example | Example | Example | Example | Comparative |
|---|---|---|---|---|---|---|
| | 1 | 2 | 3 | 4 | 5 | Example 1 |
| Resin | 100 | 100 | 100 | 100 | 100 | 100 |
| component | | | | | | |
| Functional | 30 | 30 | 30 | 30 | 30 | 30 |
| component | | | | | | |
| Folding | 100 and | 100 and | 100 and | 100 and | 100 and | 12 or less |
| Endurance | more | more | more | more | more | |
| Count (by index) | | | | | | |
| Tension Creep | 0.10 | 0.10 | 0.10 | 0.10 | 0.11 | 0.20 |
| (%) | | | | | | |
| Volume | 1 × 10¹⁰ | 1 × 10¹⁰ | 5 × 10⁹ | 2 × 10¹⁰ | 1 × 10¹⁰ | 1 × 10¹⁰ |
| Resistance | | | | | | |
| (U · cm) | | | | | | |
| Objective Image | OK | OK | OK | OK | OK | NG |
| Quality | | | | | | |
| (100,000 sheets) | | | | | | |

According to the results of the measurements and the tests, it was confirmed that the electroconductive endless-belts of the Examples had remarkable superiority in folding endurance and creep resistance.

What is claimed is:

1. An electroconductive endless-belt of tandem system for transfer and/or conveyance, which is circulatorily driven by a drive unit, and which conveys a recording medium retained on the belt by electrostatic attraction to four kinds of image formation members, and sequentially transfers each toner image onto the recording medium, characterized in that the endless belt comprises as a base material, at least one member selected from the group consisting of acrylonitrile-styrene resin containing 3 to 50 mass % of a flexible component having glass transition temperature lower than 25° C., a polymer alloy of a thermoplastic resin with acrylonitrile-styrene resin containing 3 to 50 mass % of a flexible component having glass transition temperature lower than 25° C., and a polymer blend of a thermoplastic resin with acrylonitrile-styrene resin containing 3 to 50 mass % of a flexible component having glass transition temperature lower than 25° C.

2. An electroconductive endless-belt which is used for an intermediate transfer member, is located between an image formation body and a recording medium, and is circulatorily driven with a drive unit, thereby once transferring and retaining, on the surface of itself, a toner image formed on the surface of the image formation body, and then transferring the image thereon onto the recording medium, characterized in that the endless-belt comprises as a base material, at least one member selected from the group consisting of acrylonitrile-styrene resin containing 3 to 50 mass % of a flexible component having glass transition temperature lower than 25° C., a polymer alloy of a thermoplastic resin with acrylonitrile-styrene resin containing 3 to 50 mass % of a flexible component having glass transition temperature lower than 25° C., and a polymer blend of a thermoplastic resin with acrylonitrile-styrene resin containing 3 to 50 mass % of a flexible component having glass transition temperature lower than 25° C.

3. An electroconductive endless-belt according to the claim 1 or 2, wherein the aforementioned flexible component is acrylic rubber, chlorinated polyethylene, polybutadiene rubber, ethylene propylene rubber or silicone rubber.

4. An electroconductive endless-belt according to the claim 3, wherein the aforementioned flexible component is polybutadiene rubber.

5. An electroconductive endless-belt according to the claim 1 or 2, wherein the aforementioned thermoplastic resin is a thermoplastic elastmer.

6. An electroconductive endless-belt according to the claim 1 or 2, wherein the aforementioned thermoplastic resin is polybuthylene terephthalate.

7. An electroconductive endless-belt according to the claim 1 or 2, wherein the aforementioned thermoplastic resin is polycarbonate.

8. An electroconductive endless-belt according to the claim 1 or 2, wherein the aforementioned thermoplastic resin is polyamide.

9. An electroconductive endless-belt according to the claim 5, wherein the aforementioned thermoplastic elastmer is thermoplastic polyether.

10. An electroconductive endless-belt according to the claim 1 or 2, wherein an electroconductive material is incorporated as a functional component.

11. An electroconductive endless-belt according to the claim 10, wherein the aforementioned electroconductive material is carbon black in an amount of 0.1 to 100 parts by mass based on 100 parts by mass of the base material.

12. An electroconductive endless-belt according to the claim 1 or 2, wherein the volume resistance of the belt is 10⁶ to 10¹³ μ·cm.

13. An electroconductive endless-belt according to the claim 1 or 2, wherein an engaging member engaging with a drive unit is provided on the contacting side of the belt with said drive unit.

14. An electroconductive endless-belt according to the claim 13, wherein the engaging member is a continuous protruded convexity along the rotating direction.

15. An image formation apparatus equipped with an electroconductive endless-belt according to the claim 1 or 2.
